(19) United States
(12) Patent Application Publication
(10) Pub. No.: US 2025/0341445 A1
(43) Pub. Date: Nov. 6, 2025

(54) METHOD AND APPARATUS FOR TESTING AN OPTICAL ELEMENT

(71) Applicant: OPTOFIDELITY OY, Tampere (FI)

(72) Inventors: Mikael JOKINEN, Tampere (FI); Ari NEVALAINEN, Tampere (FI); Jaakko HANNUKAINEN, Tampere (FI); Jarmo KANGASAHO, Tampere (FI); Jukka AHOLA, Tampere (FI); Ilkka ALASAARELA, Tampere (FI); David ZAUTASVILI, Tampere (FI); Janne SIMONEN, Tampere (FI); Thomas KERST, Tampere (FI)

(21) Appl. No.: 19/142,844

(22) PCT Filed: Dec. 9, 2023
(86) PCT No.: PCT/FI2023/050671

§ 371 Date: Jun. 24, 2025

Related U.S. Application Data
(60) Provisional application No. 63/477,845, filed on Dec. 30, 2022.

(51) Int. Cl. G01M 11/00

(52) U.S. Cl. CPC G01M 11/31; G01M 11/33

(57) ABSTRACT

The invention relates to a method comprising detecting a location of a sample (20); performing at least one of a reflection measurement and a transmission measurement, wherein the reflection measurement comprises: locating a projecting device and a detecting device (40) on a same side of the sample (20); detecting electromagnetic radiation reflected by the sample (20); and the transmission measurement comprises: locating the projecting device and the detecting device (40) on opposite sides of the sample (20); and detecting electromagnetic radiation transferred by the sample (20); and wherein the method further comprises using the detected electromagnetic radiation to form a test result. The invention also relates to an apparatus (1) for implementing the method.

### TECHNICAL FIELD

There is provided a method and an apparatus for testing an image transferring device.

### BACKGROUND

Some known optical elements have an input section for receiving electromagnetic signals and an output section for radiating electromagnetic signals propagated from the input section via the optical element to the output section. An example of such optical element is a waveguide a.k.a an optical waveguide. The term waveguide may also be used to describe a device functioning at radio frequencies for directing radio signals via the waveguide. However, in this specification the term waveguide is for devices capable of directing optical signals via the waveguide. Optical signals processed by waveguides may be, for example, visible light, ultraviolet light, and/or infrared light.

Image transferring devices may have many kinds of applications. For example, virtual reality (VR) glasses, augmented reality (AR) glasses and mixed reality (MR) glasses may comprise one or more waveguides to direct optical signals from a source, which forms a visual image, to produce the visual image in front of eyes of a user of the VR, AR, or MR glasses. Head-up displays (HUD) are another application in which such waveguides may be utilized.

The image transferring devices usually have very small structures which affect the propagation of optical signals. An input section may comprise a grid structure, in which narrow grooves, micro mirrors or micro lenses are formed to direct the incoming light so that it propagates inside the waveguide towards an output section. The output section may also comprise a grid structure or some other form of optical element which causes the light propagated inside the waveguide to radiate outside the waveguide.

There are also other kinds of image transferring devices such as mirror-based arrangements to transfer images from an input section to an output section e.g. for augmented reality glasses.

### SUMMARY

There is provided a method and an apparatus for testing sample capable of transferring electromagnetic radiation. The sample may be attached with a carrying device. The invention is based on the idea that a detecting device that is sensitive to electromagnetic radiation can detect electromagnetic radiation emitted by a sample, wherein the detecting device can be located with respect to the sample to at least one or two different locations, on the same and/or opposite sides of the sample. Therefore, the detecting device can receive electromagnetic radiation transferred by the sample when the detecting device is on one side of the sample and the detecting device, when it is on the opposite side of the sample, can receive electromagnetic radiation reflected by the sample.

This can be achieved so that the detecting device can physically be located on the same side of the sample where a projecting unit is located when detecting electromagnetic radiation emitted by the sample by reflection, and on the opposite side of the sample where projecting unit is located when detecting electromagnetic radiation emitted by the sample by transmission.

There is also an alignment arrangement for detecting mutual alignment at least two of the following: the projecting device, the detecting device, the carrying device and the sample.

The apparatus is a kind of an optical quality assessment arrangement, which can be used to measure electromagnetic radiation transferring devices such as image transferring devices. The sample may comprise an image input and an image output, which are physically separated on the same surface and/or on opposite surfaces of the sample.

According to a first aspect there is provided a method for testing a sample capable of transferring electromagnetic radiation, the method comprising detecting a location of a sample; performing at least one of a reflection measurement and a transmission measurement, wherein the reflection measurement comprises: locating a projecting device and a detecting device on a same side of the sample; detecting electromagnetic radiation reflected by the sample; and the transmission measurement comprises: locating the projecting device and the detecting device on opposite sides of the sample; and detecting electromagnetic radiation transferred by the sample; and wherein the method further comprises using the detected electromagnetic radiation to form a test result.

According to a second aspect there is provided an apparatus for testing a sample capable of transferring electromagnetic radiation, the apparatus comprising a projecting device and a detecting device; and a sample holder, wherein the apparatus is configured to perform at least one of a reflection measurement and a transmission measurement, wherein the apparatus is configured to perform the reflection measurement by locating the projecting device and the detecting device on a same side of the sample and detecting electromagnetic radiation reflected by the sample; wherein the apparatus is configured to perform the transmission measurement by locating the projecting device and the detecting device on opposite sides of the sample, and detecting electromagnetic radiation transferred by the sample; wherein the apparatus is further configured to use the detected electromagnetic radiation to form a test result.

Some advantageous embodiments are defined in the dependent claims.

The present invention may improve quality of testing of electromagnetic radiation transferring devices. Properties of the electromagnetic radiation transferring device under test can be measured from several different locations and from both sides. Thus, mass production may be achieved relatively easily.

### BRIEF DESCRIPTION OF THE DRAWINGS

FIGS. 1a and 1b show as a simplified manner a principle of a metrology arrangement for testing electromagnetic signal transferring devices, in accordance with an embodiment;

FIG. 2 shows as a simplified manner a testing arrangement, in accordance with an embodiment;

FIG. 3a shows as a top view an example of an optical waveguide;

FIG. 3b shows as a cross sectional side view of the optical waveguide of FIG. 3a;

FIG. 4 shows as a top view a carrying device, in accordance with an embodiment;

FIG. 5 shows a flow diagram of a method for testing an optical waveguide, in accordance with an embodiment;

FIG. 6a shows an example of a projection device, in accordance with an embodiment; and

FIG. 6b shows an example of an emitting unit, in accordance with an embodiment.

### DETAILED DESCRIPTION

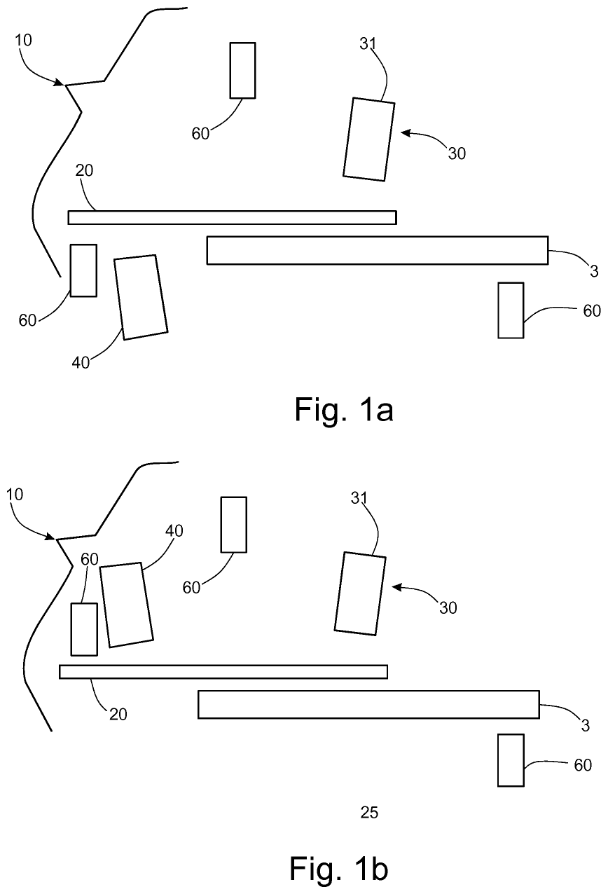

FIGS. 1a and 1b show as a simplified manner a principle of a metrology arrangement 10 for testing electromagnetic radiation transferring and/or reflecting properties of samples, in accordance with some embodiments. It should be noted that FIGS. 1a and 1b do not show any fixtures or means for moving different elements of the arrangement but just a principle of operation.

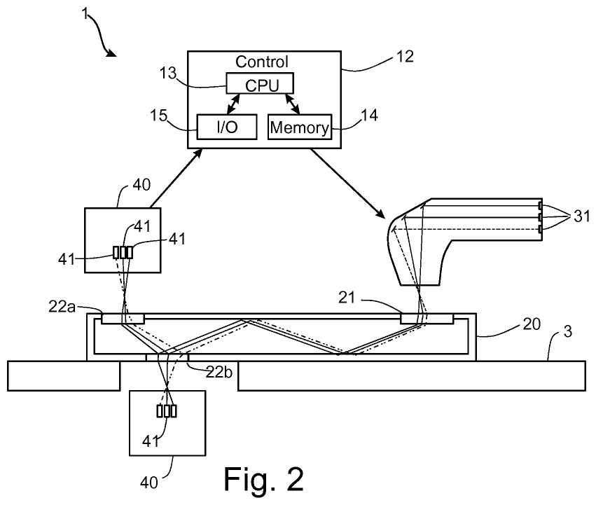

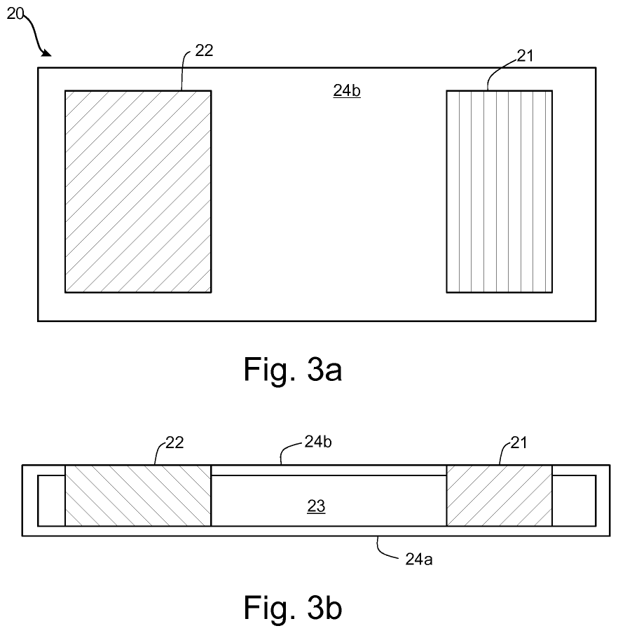

The arrangement comprises a projection device 30. The projection device 30 comprises at least one projection module 31 that delivers electromagnetic radiation to a sample 20. The sample 20 is an element not part of the present invention attached to a carrying device 3. Even though the sample 20 itself is not an element of the present invention, it is added to the description to bring clarity to it and make it easier to understand the advantages and benefits of the present invention. For example, the sample 20 is able to transfer electromagnetic radiation from an input section 21 to an output section 22 of the sample 20. It should be noted that the sample 20 may comprise separate output sections 20 for reflection and for transmission, as is illustrated in FIG. 2 with a first output section 22a and a second output section 22b.

The arrangement also comprises a carrying device 3 which may also be called as a tray or a sample tray or a sample holder. The carrying 3 device is a module to which the sample 20 can be attached for running a testing procedure. The carrying device 3 physically moves the sample 20. The carrying device 3 does not necessarily require the sample 20 to be attached to it by means of gravitational pull but may also be attached with elements applicable to keep the sample 20 attached with the carrying device 3 during the test.

There is also a detecting device 40, which is, for example, a module invention that is sensitive to electromagnetic radiation. The detecting device 40 is characterised by its ability to potentially detect electromagnetic radiation emitted from the sample 20. This electromagnetic radiation emitted from the sample may be a result of the sample having received electromagnetic radiation from the projecting device 30, but this is not necessarily the case. Emitting radiation may also mean radiation reflected by the sample 20 and/or radiation transferred via the sample 20 e.g. from the input 21 to the output 22 of the sample 20.

The detecting device 40 is able to be physically located on the same side of the sample 20 i.e. on the same side with respect to the carrying device 3 where the projecting device 30 is located. This is illustrated in FIG. 1b in which the projecting device 30 is above the sample 20 and the detecting device 40 is below the sample 20. The detecting device 40 may also be able to be physically located on the opposite side of the sample 20 where the projecting device 30 is located i.e. on the opposite side of the carrying device 3 than the projecting device 30. This is illustrated in FIG. 1a in which both the projecting device 30 and the detecting device 40 are above the sample 20. Hence, the arrangement comprises movable elements such as robotic arms which can be used to move the detecting device 40 so that the detecting device 40 is located on the same side of the sample than the projecting device 30 or on the opposite side of the sample than the projecting device 30.

In accordance with an embodiment the movable elements are able to locate the detecting device 40 to a calibration position in order to perform calibration operations to the detecting device 40. The calibration operation may comprise arranging the projection device 30 and the detection device 40 in mutual alignment so that radiation emitted from the projection device 30 is received by the detection device 40. The calibration operation may also comprise one or more other steps by which properties of the detection device 40 are examined and further calibrated.

The arrangement also comprises an alignment arrangement. The alignment arrangement comprises one or more alignment devices 60. The alignment arrangement is characterised by its ability to provide information about at least one of the following.

The information may indicate the position or orientation of the detecting device 40 with respect to the position or orientation of the projecting device 30, with respect to the position or orientation of the sample 20, with respect to the position or orientation of the carrying device 3, with respect to the position or orientation of the detecting device 40, with respect to the position or orientation of the sample 20 and/or with respect to the position or orientation of the carrying device 3.

The information may additionally or instead indicate the position or orientation of the sample 20 with respect to the position or orientation of the detecting device 40, with respect to the position or orientation of the projecting device 30 and/or with respect to the position or orientation of the carrying device 3.

The information may additionally or instead indicate the position or orientation of the carrying device 3 with respect to the position or orientation of the detecting device 40, with respect to the position or orientation of the projecting device 30 and/or with respect to the position or orientation of the sample 20.

The alignment devices 60 comprised by the alignment arrangement are not necessarily identical in nature, technology, or intended use.

An alignment device is a module of the alignment arrangement and is characterised by its ability to provide information about at least one of the following: the position or orientation of the alignment device 60 with respect to the position or orientation of the projecting device 30, with respect to the position or orientation of the sample 20 and/or with respect to the position or orientation of the carrying device 3.

An alignment device may be an electric, electronical, mechanical or optical device or a device that is a combination of electrical, electronical, mechanical or optical parts.

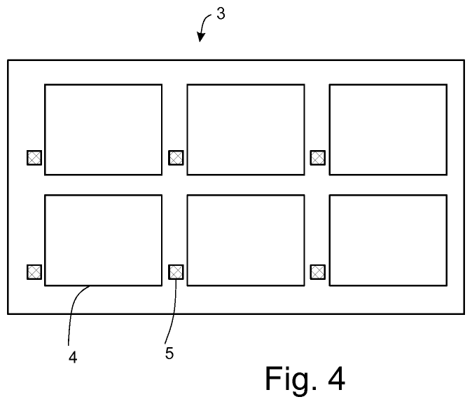

FIG. 4 illustrates an example of the carrying device 3. In this example the carrying device 3 has a plurality of sample holding sections 4 with this the sample 20 to be tested can be set. The carrying device 3 according to this example also comprises section identifiers 5. Such section identifiers are arranged beside each sample holding section 5 and they can be used to identify each sample holding section 5. Hence, when a sample is to be tested, the metrology arrangement can be informed in which sample holding section 4 a sample is and the detecting device 40 can read the code implemented in the section identifier 5. Based on the section identifier 5, the metrology arrangement is aware of the sample 20 to be tested.

In accordance with an embodiment, the detecting device 40 may scan the sample holding sections 4 and when the detecting device 40 detects that a sample holding section 4 is not empty, a testing procedure may be started for the sample 20 in that sample holding section 4.

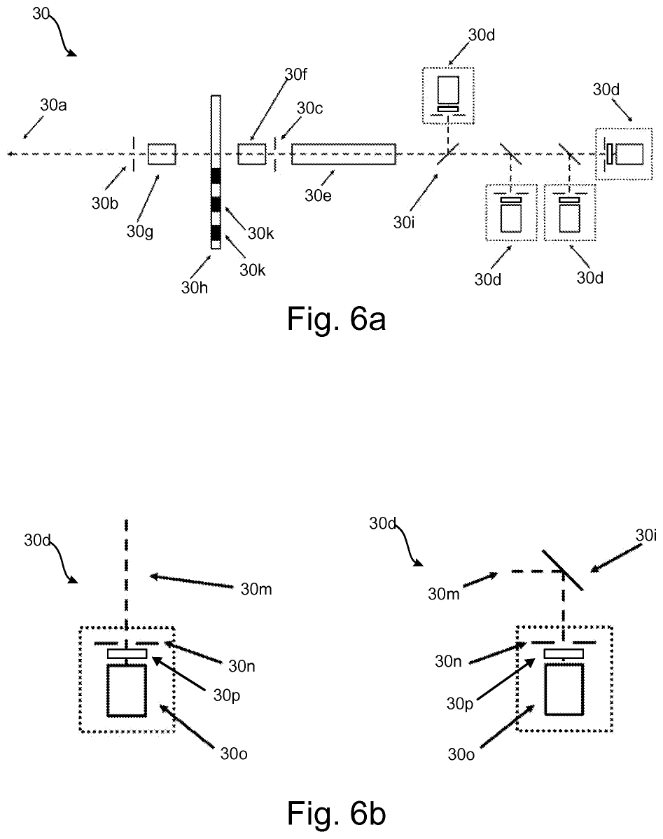

FIG. 6a shows an example of the projection device 30, in accordance with an embodiment and FIG. 6b shows an example of an emitting unit 30d, in accordance with an embodiment. An optical axis 30a defines the principal direction into which the projecting device 30 delivers electromagnetic radiation. The optical axis 30a crosses the centres of both an outer pupil 30b and an inner pupil 30c. The direction into which the projecting device 30 delivers electromagnetic radiation is not limited to the optical axis 30a. However, the optical axis 30a defines the direction to which all other elements inside the projecting device 30 are referenced.

The outer pupil 30b defines the location from which the projecting device 30 delivers electromagnetic radiation. The outer pupil 30b may be a physical aperture, or an image of the inner pupil 30c brought about by an image-forming element 30g and a second light-manipulating element 30f or a combination of both. The inner pupil 30c limits the amount and the extent to which electromagnetic radiation delivered by emitting units 30d and shaped by a first light-manipulating element 30e is passed to the second light-manipulating element 30f. The inner pupil 30c may be a physical element and may be a physical plate, or an iris or any other element that physically limits the spatial extent of electromagnetic radiation. The inner pupil 30c is located between the first light-manipulating element 30e and the second light-manipulating element 30f.

The image-forming element 30g is located between a movable pattern-carrying device 30h and the second light-manipulating element 30f. It is characterized by its ability to project the inner pupil 30c onto the outer pupil 30b, if combined with the second light-manipulating element 30f. The image-forming element 30g is further characterised by its ability to project a pattern 30k from the moveable pattern-carrying device 30h onto an image plane defined by the imaging-forming element 30g.

The second light-manipulating element 30f is located between the movable pattern-carrying device 30h and the inner pupil 30c. It is characterised by its ability to project field stop apertures 30n of the plurality of emitting units 30d onto the movable pattern-carrying device 30h, if combined with the first light-manipulating element 30e.

The first light-manipulating element 30e is located between the inner pupil 30c and the plurality of emitting units 30d. It is characterised by its ability to project the field stop apertures 30n of the plurality of emitting units 30d onto the movable pattern-carrying device 30h, if combined with the second light-manipulating element 30f.

The movable pattern-carrying device 30h is located between the second light-manipulating element 30f and the image-forming element 30g. It is characterised by its ability to move one or more patterns 30k of a plurality of patterns into the physical location where the second light-manipulating element 30f and the first light-manipulating element 30e project the field stop apertures 30n of the plurality of emitting units 30d.

A pattern 30k is a physical element on the moveable pattern-carrying device 30h that is characterised by its ability to shape electromagnetic radiation, if brought into contact with it.

A pattern 30k may also be formed by a spatial modulator that is characterized by its ability to variably shape electromagnetic radiation, if brought into contact with it. In that case, the pattern-carrying device does not need to be movable as the pattern can be varied by the spatial modulator.

The emitting unit 30d is a combination of a radiation generating and shaping unit 30o and a field stop aperture 30n. The emitting unit 30d may contain one or more exchangeable elements 30p. An emitting unit 30d is defined by emitting unit axis 30m and may or may not comprise an optional combining element 30i. The projecting device 30 always comprises more than one or at least one emitting unit 30d.

The field stop aperture 30n of an emitting unit 30d limits the amount and the extent to which electromagnetic radiation delivered by the radiation generating and shaping unit 30o is passed to the first light-manipulating element 30e. The field stop aperture 30n may be a physical element and may be a physical plate, or an iris or any other element that physically limits the spatial extent of electromagnetic radiation. The field stop aperture 30n is located behind the radiation generating and shaping unit 30o of an emitting unit 30d. the emitting unit 30d may contain one or more exchangeable elements 30p. The field stop aperture 30n may be located behind the exchangeable element 30p, too.

The radiation generating and shaping unit 30o is characterised by its ability to emit electromagnetic radiation. The radiation generating and shaping unit 30o may comprise one or more elements that shape or pattern the electromagnetic radiation, but it is not necessarily so.

The exchangeable element 30p of an emitting unit 30d is located between the field stop aperture 30n and the radiation generating and shaping unit 30o. The exchangeable element 30p is entirely optional and the emitting unit 30d is not required to contain one or more exchangeable elements 30p. However, the emitting unit 30d may have provisions such that at least one exchangeable element 30p may be added to this emitting unit 30d.

A single exchangeable element 30p may comprise any physical element that alters the amount, direction, extent or spectrum of the electromagnetic radiation delivered by the radiation generating and shaping unit 30o.

Adding or removing of a single exchangeable unit 30p may happen via a manual or machine-guided insertion of the physical element that alters the amount, direction, extent or spectrum of the electromagnetic radiation delivered by the radiation generating and shaping unit 30o. It is not necessary that all exchangeable units 30p are added or removed either manual or machine-guided. If more than one exchangeable element 30p is used, then some elements may be added and removed manually, and some may be added and removed with the help of a machine.

The emitting unit axis 30m defines the principal direction into which the emitting unit 30d delivers electromagnetic radiation. The emitting unit axis 30m points in the same or close to the same direction as the optical axis 30a. An emitting unit 30d may comprise a combining element 30i for the purpose of redirecting the emitting unit axis, such that it can be made to point in the same or close to the same direction as the optical axis 30a.

The direction into which the emitting unit 30d delivers electromagnetic radiation is not limited to the emitting unit axis. However, the emitting unit axis defines the direction to which the emitting unit 30d is oriented such that the emitting unit axis and the optical axis 30a point in the same or close to the same direction.

The combining element 30i is an element that may be positioned between the emitting unit 30d and the first light-manipulating element 30e. It is defined by its ability to redirect the emitting unit axis 30m of an emitting unit such that the emitting unit axis 30m and the optical axis 30a point in the same or close to the same direction. The combining element 30i may be able to combine the electromagnetic radiation delivered by one or more emitting units 30d, such that the emitting axes 30m of all emitting units 30d point in the same or close to the same direction.

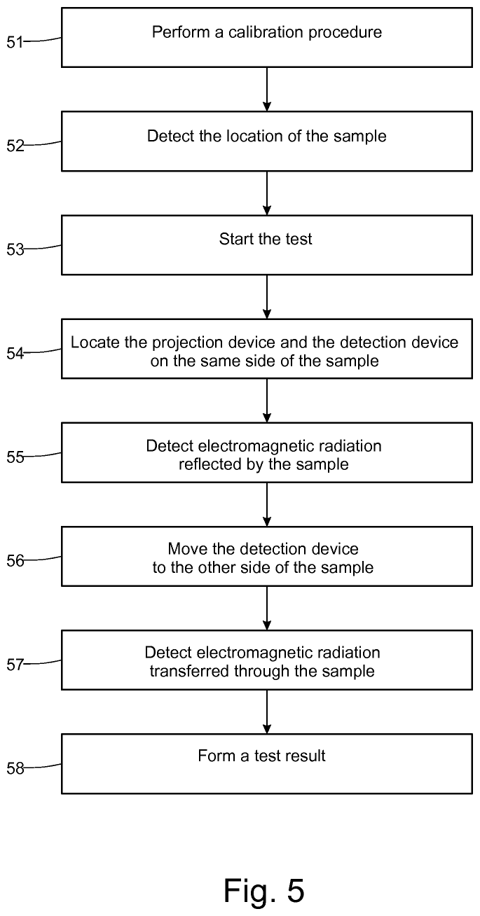

A method according to an embodiment will now be described using the metrology arrangement of FIG. 2 as an example, with reference to the flow diagram of FIG. 5. The sample 20 is attached with the carrying device 3. The metrology arrangement may first perform a calibration procedure 51. The calibration procedure may comprise one or more of the following: the projection device 30 and the detection device 40 are moved to a location in which they are vertically aligned wherein the detection device 40 can receive the electromagnetic radiation from the projection device 30. Such a location may be outside the carrying device 3 or the carrying device 3 may comprise a transparent section such as a through-hole via which the electromagnetic radiation can propagate.

The calibration procedure may also comprise a step in which the detection device 40 is directed to a location in which the detection device 40 is directed to a calibration image. The detection device 40 can then form a reference image to be used to calibrate the detection device 40 accordingly.

After the calibration procedure is completed, the metrology arrangement detects 52 the location of the sample 20 to be tested and start 53 the test procedure. The metrology arrangement controls the location of the projection device 30 and the detection device 40. First, the projection device 30 and the detection device 40 can be located 54 on the same side of the sample 20, as is illustrated in FIG. 1b. In this mode the detection device 40 detects 55 electromagnetic radiation reflected by the sample 20. Then, the detection device 40 can be moved 56 on the opposite side of the sample 20 with respect to the projection device 30, as is illustrated in FIG. 1a. In this mode the detection device 40 detects 57 electromagnetic radiation travelled through the sample 20 (i.e. penetrated the sample) for example from the input section to the second output section 22b. The testing results can be collected and the test is ended 58.

It should be noted that it is also possible to arrange the order of the reflection test and the transmission test the other way around, i.e. testing first the transmission and then the reflection.

As a further note, FIG. 2 depicts the detection device 40 in two locations, namely above and below the carrying device 3, but in practice the detection device 40 is not simultaneously in two places, but can move between these two locations and also according to the calibration procedure explained above.

There may also be two detection devices 40, one above and one below the carrying device 3.

The above-mentioned testing procedure can be implemented, for example, with a software stored into a memory 14 and executed by a processor 13 of a control device 12. Control signals to the projection device 30, the detection device 40 and possible movement elements can be generated by the processor and transformed to appropriate electric signals by the input/output block 15, for example. Correspondingly, the input/output block 15 can be used to receive information from the detection device 40.

The control device 12 can also have a user interface 15 (e.g. a display and a keyboard) with which a user can instruct the testing apparatus 1 to perform testing and to receive information of test results.

The output of the test procedure may depend on what kind of tests are performed. The output may be, for example, a pass/fail type of output, an indication of properties of the waveguide 20 at certain areas (e.g. how well certain light beams 2 were preserved when travelled through the waveguide 20), a visual image such as an intensity map, etc.

In accordance with an embodiment, the electric signals are converted to digital samples by an analogue-to-digital converter (not shown) and the samples are then provided to the control device 12. In accordance with another embodiment, the control device 12 comprises a converter which performs the conversion from analogue signals to digital samples.

The projection modules 31 may be any devices capable to emit electromagnetic radiation having wavelength somewhere in a range from ultraviolet to infrared, depending on which kind of sample 20 are to be tested.

In accordance with an embodiment, the projection modules 31 comprise light emitting diodes (LED) as light sources.

In accordance with an embodiment, the projection modules 31 comprise laser diodes as light sources.

In accordance with an embodiment, the projection modules 31 emit visible light. As an example, the projection modules 31 emit white light.

In accordance with an embodiment, a projection module 31 comprises light sources which emit visible light of different colour. As an example, one light source emits red light, another light source emits green light, and another light source emits blue light.

In accordance with an embodiment, one or more light sources emit visible light, and one or more other light sources 38 emit light not visible by human eye, such as ultra violet and/or infrared light.

The invention has several advantages. Some of them are described below as examples.

The possibility to place the detecting device 40 on either side of the sample permits to measure the quality of the sample 20 for two entirely different use-cases. This way, the invention combines two machines into one and makes the measurement of the sample 20 faster and cheaper.

By using the alignment arrangement, the precise position of the sample 20 to the detecting device 40 and the projecting device 30 is known, thereby enabling a measurement of the sample 20 that is much more accurate than it would be the case of no alignment arrangement would be utilized.

By using a carrying device 3, the present invention is capable of potentially being integrated into other machines or devices making use of the same carrying device 3, thereby enabling faster moving and handling of the sample 20. By using an outer pupil 30b in the projecting device 30, the projecting device 30 can deliver electromagnetic radiation to specific samples 20 requiring the delivery of electromagnetic radiation to the outer pupil 30b defined that way. AR/VR/MR devices are often such devices and require electromagnetic radiation to be delivered in precisely this way, thus making the invention an improvement to other approaches.

The combination of the second light-manipulating element 30f, the first light-manipulating element 30e and the inner pupil 30c in exactly the way shown in FIG. 6a enable the manipulation and forming of the outer pupil 30b without the need to physically interact with the outer pupil 30b. This way to change the outer pupil 30b without direct interaction with it is a clear advantage for scenarios where many different samples of varying outer pupil sizes and shapes need to be tested.

The movable pattern-carrying device 30h inside the projecting device 30 carrying multiple patterns 30k allows the image-forming element 30g to form many different images for testing of the sample 20 for different metrics. Regular testing devices tend to have a single pattern permanently installed, thus allowing for only one specific test of sample associated with the installed pattern. The moveable pattern-carrying device 30h enables many different tests with a single projecting device 30, thus presenting a clear improvement to typical testing of samples.

The potential use of an exchangeable element 30p in each emitting unit 30d allows to shape the amount, direction, extent or spectrum of the electromagnetic radiation the emitting unit 30d delivers. By adding such an exchangeable element 30p to an emitting unit 30d, the invention becomes flexible and can accommodate many kinds of samples 20 with different needs for electromagnetic radiation delivered with varying amounts, directions, extents and spectra.

1. A method for testing a sample capable of transferring electromagnetic radiation, the method comprising
detecting a location of a sample;
performing at least one reflection measurement and at least one transmission measurement, wherein the reflection measurement comprises:
locating a projecting device and a detecting device on a same side of the sample;
detecting electromagnetic radiation reflected by the sample; and
the transmission measurement comprises:
locating the projecting device and the detecting device on opposite sides of the sample; and
detecting electromagnetic radiation transferred by the sample; and
wherein the method further comprises
using the detected electromagnetic radiation to form a test result,
wherein the detecting device is moved from the reflection measurement location to transmission measurement location between the reflection measurement and the transmission measurement.

2. The method according to claim 1, said locating the projecting device and the detecting device on opposite sides of the sample comprising:
moving either the detecting device or the projecting device to the opposite side of the sample.

3. The method according to claim 1 comprising:
performing both the reflection measurement and the transmission measurement; and
using both the detected reflected electromagnetic radiation and the detected transferred electromagnetic radiation to form the test result.

4. An apparatus comprising
a projecting device;
a detecting device; and
a sample holder;
wherein the apparatus is configured to perform at least one reflection measurement and at least one transmission measurement,
wherein the apparatus is configured to perform the reflection measurement by locating the projecting device and the detecting device on a same side of the sample and detecting electromagnetic radiation reflected by the sample;
wherein the apparatus is configured to perform the transmission measurement by locating the projecting device and the detecting device on opposite sides of the sample, and detecting electromagnetic radiation transferred by the sample;
wherein the apparatus is further configured to use the detected electromagnetic radiation to form a test result,
wherein the detecting device is configured to be moved from the reflection measurement location to transmission measurement location between the reflection measurement and the transmission measurement.

5. The apparatus according to claim 4 further comprising an actuator for moving at least one of the detecting device and the projecting device, wherein said actuator is configured to locate the projecting device and the detecting device on opposite sides of the sample.

6. The apparatus according to claim 5 configured to:
perform both the reflection measurement and the transmission measurement; and
use both the detected reflected electromagnetic radiation and the detected transferred electromagnetic radiation to form the test result.
